(19) United States
(12) Patent Application Publication
(10) Pub. No.: US 2010/0157625 A1
(43) Pub. Date: Jun. 24, 2010

(54) METHOD FOR DISPLAYING MULTIPLE VIEWS

(76) Inventors: Chien-Chin Mai, Kaohsiung City (TW); Jui-Tang Yin, Kaohsiung City (TW); Yeong-Feng Wang, Kaohsiung City (TW)

Correspondence Address: LEONG C LEI, PMB # 1008, 1867 YGNACIO VALLEY ROAD, WALNUT CREEK, CA, 94598, US

(21) Appl. No.: 12/342,085

(22) Filed: Dec. 23, 2008

(51) Int. Cl. F21V 7/04

(52) U.S. Cl. 362/613; 362/618

(57) ABSTRACT

Disclosed is a method for displaying multiple views, including forming a light guide plate having edge faces forming different-direction light incidence surfaces, setting light sources corresponding to the different-direction light incidence surfaces respectively, operating the light sources that correspond to the different-direction light incidence surfaces to respectively give off lights in a fast and intermittently alternating manner, deflecting the lights to respective predetermined orientations with the light guide plate, further deflecting the lights to desired orientations with optic films set on the light emission surface of the light guide plate, and operating a liquid crystal panel to realize control of signals for different images so as to show multiple views with the light sources that give off lights in different directions and the signals of the different images.

### TECHNICAL FIELD OF THE INVENTION

The present invention relates generally to a method for displaying multiple views and a device thereof, and in particular to a technique that is applicable to operating a plurality of light sources for controlling a displaying device to show multiple views.

### DESCRIPTION OF THE PRIOR ART

It is commonly known that a displaying device shows a single view of image. However, under particular circumstances, a displaying device showing only a single view is not sufficient to suit practical needs. For example, an in-car displaying device may need to display data of a global positioning system (GPS) for a driver and at the same time, also show an image of other multimedia, games, or videos for a passenger. Although two sets of displaying panels may be used to realize simultaneous display of two different views or image, yet an additional amount of the very limited space inside a car is occupied. Further, the manufacturing costs of the in-car displaying system must be increased. A single displaying device that is capable of showing dual views or even triple views on a single display screen or display panel would be a solution to such a need.

Heretofore, a single displaying device simultaneously showing two views is realized through image shielding means. An example is shown in FIG. 1 of the attached drawings, wherein a display panel 1, such as thin-film-transistor (TFT) liquid crystal display (LCD) is provided with a parallax screen 2 set outside the display. The parallax screen 2 comprises an non-transparent substrate 21 in which apertures 22, which are made completely penetrating the substrate or otherwise made light transmitting, is formed in an array. The display panel 1 comprises an array of pixels 11 for displaying images. The apertures 22 of the parallax screen 2 are set corresponding to the pixels 11 of the display panel 1 respectively, whereby each pixel 11 is partially shielded by a portion of the non-transparent substrate 21. When light emits from the pixels 11, the light ray from each pixel 11 is allowed to partly transmit through the respective aperture 22, while the remaining portion of the light ray is blocked by the non-transparent substrate 12 of the parallax screen 2. By controlling the lights representing different images to project in respective different directions, different views can be obtained at different viewing angles. Thus, viewers at different viewing angles can see different views A, B. In this way, a single displaying device simultaneously showing two different views is realized.

Also, as shown in FIG. 2, the parallax screen 2 can be used to make images stereographic. The pixels 11 of the display panel 1 are divided into those corresponding to a left-eye image for a viewer and the remaining corresponding to a right-eye image for the viewer. Due to the result of light ray shielding realized by the parallax screen 2, and with the two eyes of the viewer being positioned at the optimum zones of viewing windows of the left-eye image and the right-eye image, the viewer can see the right-eye image with only his or her right eye RE, while the left eye LE sees only the left-eye image. In this way, a three-dimensional image can be observed by the viewer.

The above descried conventional devices sets a parallax in the displaying device to shield fifth percent of the pixels so that lights representing different images or views are projected in different directions to realize displaying different views at different viewing angles. However, since the parallax screen 2 must shield or block some pixels 11, the efficiency of use of the light source for the displaying device is lowered. In addition, cutting and manufacturing of the apertures 22 of the non-transparent substrate 21 of the parallax screen 2 are difficult, making the costs of the displaying devices that are capable of simultaneously displaying two views very high.

In view of the above problems of the known devices for simultaneously displaying two views, the present invention aims at providing a displaying device that is capable of simultaneously showing multiple views at low cost.

### SUMMARY OF THE INVENTION

An objective of the present invention is to overcome the problem that a conventional multiple-view displaying device that uses a parallax screen to partially block pixels of the displaying device for formation of different views at different viewing angle by projecting lights representing different views in different directions has a low efficiency of use of a light source of the displaying device and the difficulty of manufacturing thereof.

An aspect of the present invention is to provide a method for displaying multiple views and a device thereof, wherein an edge type backlight module is provided, having a light guide plate that has edge faces forming light incidence surfaces at different directions. Light sources are respectively set outside the different-direction light incidence surfaces. The light sources that correspond to the different-direction light incidence surfaces are operated to respectively give off lights in a fast and intermittently alternating manner. The lights are deflected by the light guide plate to respective predetermined orientations. The light emission surface of the guide plate is further provided with optic films that further deflect the lights to desired orientations. A liquid crystal panel is provided to realize control of signals for different images so as to show multiple views with the light sources that give off lights in different directions and the signals of the different images.

Another aspect of the present invention is to provide a method for displaying multiple views and a device thereof, wherein a direct backlight module is divided into zones that respectively comprise of light sources giving off lights in different directions to a diffusion board in a fast and intermittently alternating manner. The light emission surface of the diffusion board is further provided with the optic films to deflect the lights to respective desired orientations. A liquid crystal panel is provided to control signals for different images, so as to show multiple views with the light sources that give off lights in different directions and the signals of the different images.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view illustrating a conventional displaying device that shows two views.

FIG. 2 is a schematic view of another conventional displaying device.

FIG. 3 is a schematic view of a displaying device for displaying multiple views in accordance with the present invention.

FIG. 4 is a schematic view illustrating the process of showing multiple views with a single displaying device in accordance with the present invention.

FIG. 5 is a schematic view of a displaying device for displaying multiple views in accordance with another embodiment of the present invention.

FIG. 6 is a schematic view illustrating the process of showing multiple views with a single displaying device in accordance with said another embodiment of the present invention.

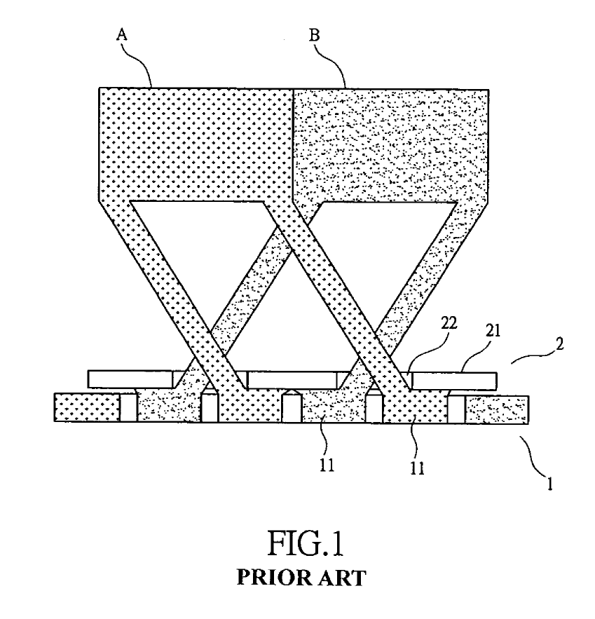

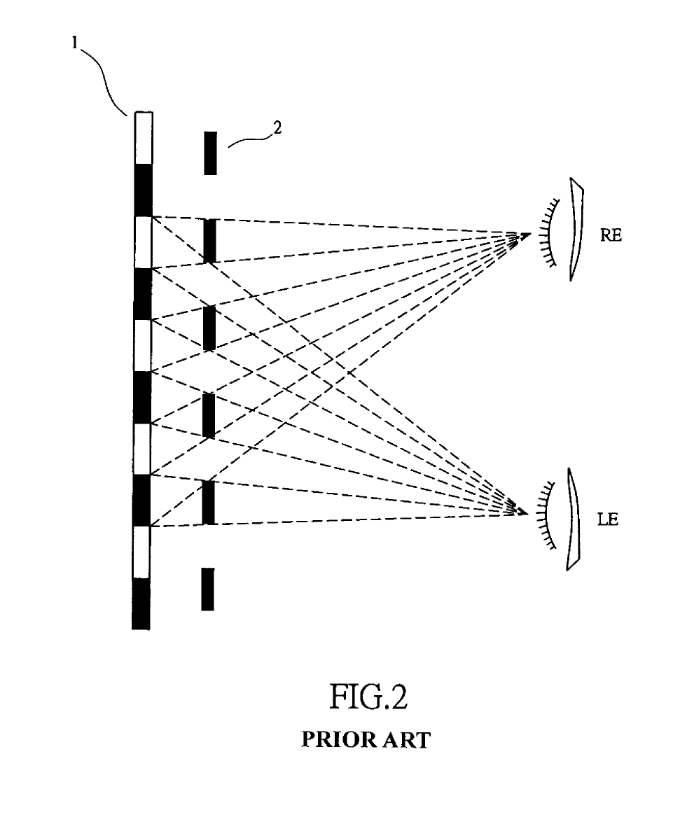

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

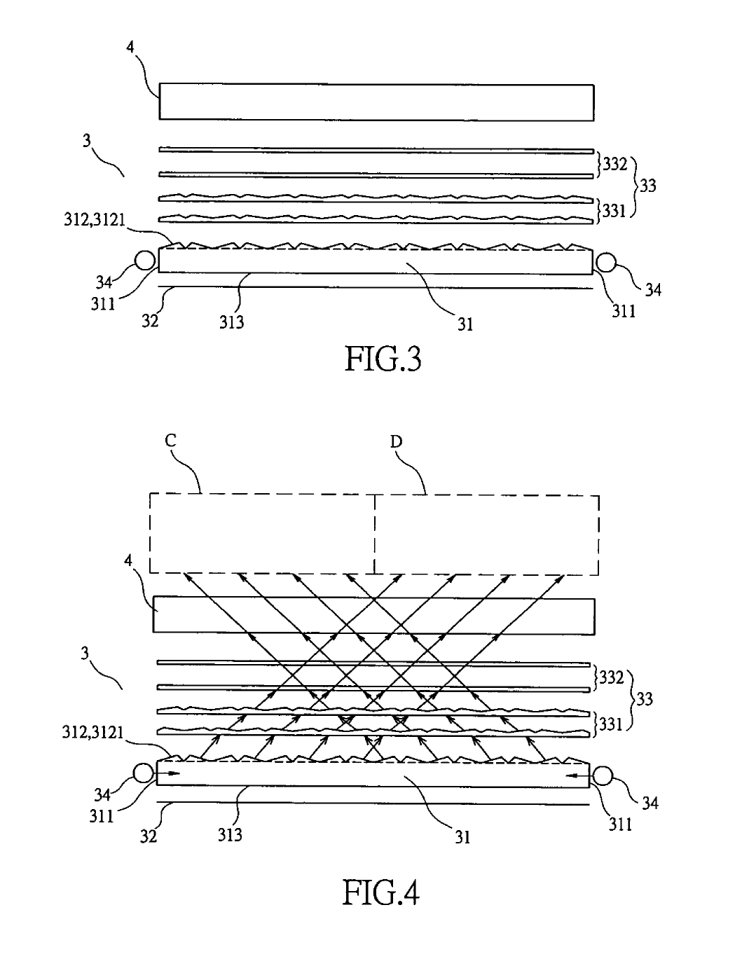

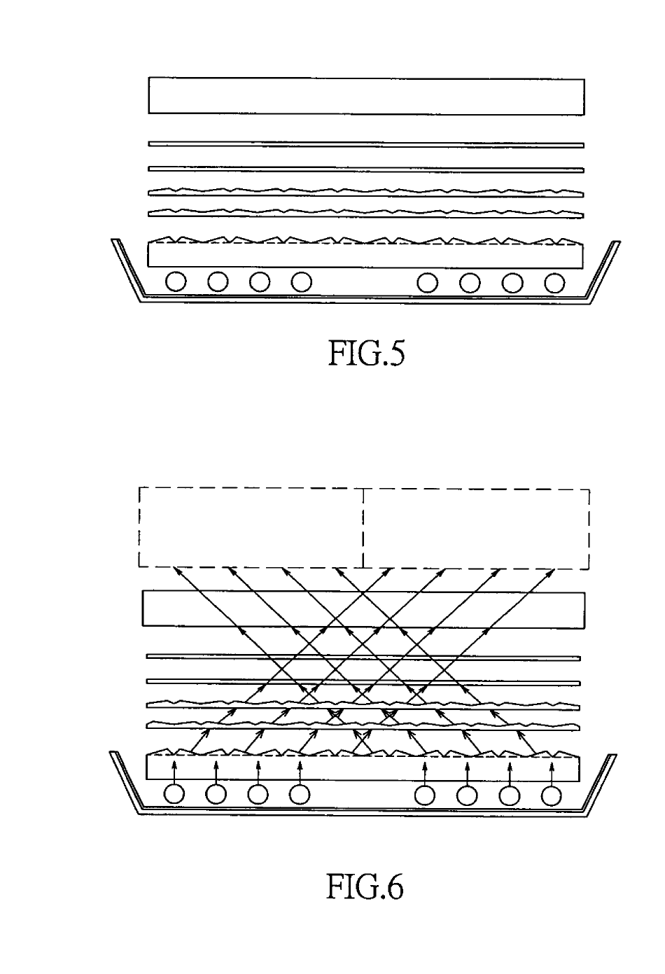

With reference to the drawings and is particular to FIG. 3, the present invention comprises a backlight module 3 and a liquid crystal panel 4.

The backlight module 3, which is an edge type backlight module in the embodiment illustrated, comprises a light guide plate 31, a reflector plate 32, a plurality of optic films 33, and light sources 34. The light guide plate 31 has edge faces, serving as light incidence surfaces 311 of the light guide plate 31 at different directions. The light guide plate 31 has a top serving as a light emission surface 312. Opposite to the light emission surface 312 is a reflection surface 313 of the light guide plate 31. At least one of the light emission surface 312 and the reflection surface 313 (light emission surface 312 being taken as an example in the instant embodiment of the present invention) is provided with light guide prisms 3121. The plurality of optic films 33 is set above the light emission surface 312. The optic films 33 include a condensation film 331 and a diffusion film 332 that respectively effect condensation and diffusion of light rays. The light sources 34 are arranged to correspond to the various light incidence surfaces 311 of various edge faces of the light guide plate 31. The light sources 34 may comprise cold cathode fluorescent lamps (CCFLs) or light-emitting diodes (LEDs).

The liquid crystal panel 4 is arranged above the backlight module 3. The liquid crystal panel 4 comprises thin film transistors (TFTs) and a color filter (CF) (not shown), both being formed with arrangements of tiny and corresponding arrays.

Also referring to FIG. 4, displaying multiple views in accordance with the present invention is to set the light sources 34 respectively correspond to the light incidence surfaces 311 of the light guide plate 31 at different directions. The light sources 34 correspond to the different-direction light incidence surfaces 311 of the light guide plate 31 are operated to provide lights to the light guide plate 31 in a fast and intermittently alternating manner. Taking FIG. 4 as an example, when the right-hand side light source 34 is activated to give off light, the left-hand side light source 34 are temporarily shut down to not give off light. On the other hand, when the left-hand side light source 34 is activated to give off light, the right-hand side light source 34 is shut down and does not give off light. The lights, when entering the light guide plate 31, is guided to project outward at respective, given angles through the light guide prisms 3121 formed on the light emission surface 312 of the light guide plate 31 and the light is subjected to further processing by the condensation film 331 that is arranged above the light emission surface 312 of the light guide plate 31 for being further deflected to a desired, predetermined orientation, whereby the light that is so supplied t the liquid crystal panel 4 can show a desired image or view. A portion of the light that leaks out of the light guide plate 31 is re-directed back to the light guide plate 31 by the reflector plate 32 for re-use of the portion of the light. The present invention uses the light sources 34 that are set to correspond to different-direction light incidence surfaces 311 of the light guide plate 31 and are operated to emit lights in a fast and intermittently alternating manner. This, together control realized through the liquid crystal panel 4 to fast switch the emission or transmission of lights or signals representing different views or images. Thus, due to persistence of vision of a viewer, which allows the image or view to leave on the retinas of the viewer's eyes for around one twentieth seconds after the image or view has actually disappeared, a continuous motion of the image is mistakenly perceived by the eyes of the viewer. In this way, the liquid crystal panel 4 allows viewers to see different images or views C, D at different viewing angles.

Referring to FIG. 5, the present invention is also applicable to a direct backlight module, wherein the direct backlight module 5 comprises a casing 51, a plurality of light sources 52, and a diffusion board 53.

The casing 51 has a top opening 511 and the casing is gradually reduced, in cross-section thereof, from the opening 511 toward a bottom thereof. The casing 51 may have inside surfaces that are made shining or to which a reflection film 512 is attached, whereby the casing 51 may reflect the light from the light sources.

The light sources 52 may include CCFLs or LEDs and the light sources 52 are arranged on the bottom of the casing 51 in a side-by-side distributed manner with the diffusion board 53 located above the light sources 52.

The diffusion board 53 comprises a board body in which diffusion beads are implanted and mixed to uniformly spread the light transmitting therethrough. The diffusion board 53 is set above the light sources 52 and closes the opening 511 of the casing 51.

In practice, the direct backlight module 5 is divided into different zones, wherein the light sources 52 belonging to the different zones are operated to emit lights in different directions to the diffusion board 53 in a fast and intermittently alternating manner. The diffusion board 53 has a light emission surface 531 above which optic films 54 are arranged for further deflecting the light to a desired, predetermined orientation. This, together control of signals or lights of different views realized through the liquid crystal panel 6, allows the light sources that give off lights at different angles to work with the lights or signals of different images or views to display multiple views.

The effectiveness of the present invention is that light sources 34 are set at locations corresponding to light incidence surfaces 311 of different edge faces of the light guide plate 31 of the backlight module 3 and the light sources 34 corresponding to different-direction light incidence surfaces 311 are operated to emit light in a fast and intermittently alternating manner; the light guide prisms 3121 of the light guide plate 31 respectively induce deflection of light at a respective, particular angle; the light emission surface 312 of the light guide plate 31 is further provided with a condensation film 331 for further deflecting the light to a desired orientation; and the liquid crystal panel 4 operates to control the emission of light signals associated with different views, whereby multiple views can be obtained through the light sources that give off lights in different angles and the signals associated with different views. Or, the direct backlight module 5 is divided into multiple zones, respectively comprising light sources 52 giving off lights in different directions toward the diffusion board 53 in a fast and intermittently alternating manner; an light emission surface 531 of the diffusion board 53 is further provided with optic films 54 that further deflect the light toward a desired orientation; and the liquid crystal panel 6 controls the light signals of different views, whereby the light sources that give off light at different angles and the control of signals for different views realized through the liquid crystal panel 6 allow the display of multiple views. In this way, the backlight module 3, 5 can simultaneously show multiple views without using a parallax screen, and costs can thus be reduced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for displaying multiple views comprising forming a light guide plate having edge faces forming different-direction light incidence surfaces, setting light sources corresponding to the different-direction light incidence surfaces respectively, operating the light sources that correspond to the different-direction light incidence surfaces to respectively give off lights in a fast and intermittently alternating manner, deflecting the lights to respective predetermined orientations with the light guide plate, and operating a liquid crystal panel to realize control of signals for different images so as to show multiple views with the light sources that give off lights in different directions and the signals of the different images.

2. A device for displaying multiple views, comprising at least an edge type backlight module, which comprises:
a light guide plate having a light emission surface and a reflection surface opposite to the light emission surface, at least one of the light emission surface and the reflection surface being provided with light guide prisms, and edge faces forming a plurality of light incidence surfaces;
a reflector plate, which is disposed on the reflection surface of the light guide plate;
a plurality of optic films, which is set above the light emission surface of the light guide plate; and
light sources, which are set to respectively correspond to the plurality of light incidence surfaces of the light guide plate;
wherein the light sources corresponding to different edge faces of the light guide plate are operated to give off lights in a fast and intermittently alternating manner and wherein the lights are deflected toward respective predetermined orientations through light guide prisms of the light guide plate, the lights being further deflected by the optic films to desired directions.

3. The device according to claim 2, wherein the optic films comprise a light condensation film.

4. The device according to claim 2, wherein the optic film comprise a light diffusion film.

5. The device according to claim 2 further comprising a liquid crystal panel arranged above the backlight module.

6. The device according to claim 2, wherein the light sources comprise cold cathode fluorescent lamps.

7. The device according to claim 2, wherein the light sources comprise light-emitting diodes.

8. A device for displaying multiple views, comprising at least a direct backlight module, which comprises:
a casing having an inside surface forming a shinning surface or being provided with a reflection film;
a plurality of light sources, which is arranged on a bottom of the casing;
a diffusion board, which is set above the light sources and has a light emission surface; and
a plurality of optic films, which is set above the light emission surface of the diffusion board; and
wherein the direct backlight module is divided into zones in which the light sources are set, the light sources belonging to different ones of the zones being operated to give off lights in different directions to the diffusion board in a fast and intermittently alternating manner and wherein the light emission surface of the diffusion board is provided with the optic films to deflect the lights to respective predetermined orientations, a liquid crystal panel being operated to control signals for different images, so as to show multiple views with the light sources that give off lights in different directions and the signals of the different images.
